(19) United States
(12) Patent Application Publication
(10) Pub. No.: US 2010/0213109 A1
(43) Pub. Date: Aug. 26, 2010

(54) REVERSE-FLOW SELF-RINSING FLUID FILTERS

(75) Inventor: Raanan Ben-Horin, Jordan Valley (IL)

Correspondence Address: DUBOIS, BRYANT, CAMPBELL & SCHWARTZ, LLP, 700 LAVACA STREET, SUITE 1300, AUSTIN, TX, 78701, US

(73) Assignee: ARKAL FILTRATION SYSTEMS C.S. LTD., Beit-Zera (IL)

(21) Appl. No.: 12/520,049

(22) PCT Filed: Dec. 19, 2006
(86) PCT No.: PCT/IL2006/001460

§ 371 Date: Jun. 18, 2009

(51) Int. Cl. B01D 29/46; B01D 35/157; B01D 29/66

(52) U.S. Cl. 210/136; 210/225

(57) ABSTRACT

A reverse flow rinsing fluid filtering device, particularly for large diameter piping. Housing (12) has inlet port (14), outlet port (20) and a battery of filtering discs divided into three groups D1, D2 and D3 by partition rings 80a and 80b. In the rinsing stage, when the filtering discs become separated from each other, the discs of each group are supported on one of the partition rings thereby reducing the effect of the self-weight of the discs

### FIELD OF THE INVENTION

The present invention relates to fluid filters. The invention particularly concerns discs filters of the reverse flow, self-rinsing or flushing type as widely used in agricultural water irrigation installations. More specifically the invention is closely related—though not limited—to filters of the kind disclosed in our International Publication WO 99/30796 published Jun. 24, 1999.

### BACKGROUND OF THE INVENTION

It has been recognized that the efficiency of the conventional disc filters of the kind referred to above derogates as function of the increase of the filter discs diameter, and more so with the increase of their number, namely to the overall axial length of the filter unit, and in particular in cases where the filters are vertically positioned.

FIGS. 1a and 1b schematically explains this effects: During the filtering stage the discs D forms a compact battery or stack, compressed under the force of a spring loaded piston P against a fixed support S; when rinsing is requested, the piston P is relived and rises up, allowing the separation of the discs from each other and the formation of the gaps for the rinsing water to flow therebetween.

However, due to the accumulated self-weight, the discs located nearer to the bottom of the battery are impeded from spacing away, as shown in FIG. 1b. The efficiency of the rinsing thus decreases in proportion with the distance of any given disc from the bottom, fixed support S of the pile.

The same applies should the fixed support be located at the top and the movable piston at the bottom, (see FIGS. 7 and 8 below).

It is therefore the prime object of the present invention to overcome the above described deficiency of the conventional filtering devices.

It is a further object of the invention to gain control over the self-weight factor in order to neutralize the undesirable effect thereof.

It is a further object of the invention to divide the pack of discs into several groups, each group being neutralized from the weight of the group next above it during the reverse flow rinsing stage of operation.

### SUMMARY OF THE INVENTION

According to the invention there is provided a fluid filtering device comprising a housing with an inlet port for the fluid to be filtered and an outlet port for the filtered fluid; a battery of filtering discs positioned in the path of the fluid between the inlet and the outlet ports; means for applying a compacting force on the battery of discs during the filtering stage of the device, and means for reliving said force for enabling the displacement of the discs away from each other during the rinsing stage wherein the fluid flows from the outlet port through gaps formed between adjacent discs, characterized in that partition means are provided between any given number of discs, dividing the battery of discs into groups whereby in the rising stage each group is supported on one of said partition means.

The partition means may comprise rings coupled to the piston via step-wise spacing means so that movement of the piston in the discs relieving direction is transmitted first to the partition ring which is closer to the piston, than to a more remotely located partition ring, and so forth with respect to the remaining partition rings.

### BRIEF DESCRIPTION OF THE DRAWINGS

These and additional constructional features and advantages of the invention will be more readily understood in the light of the ensuing description of several preferred embodiments thereof, given by way of example only, with reference to the accompanying drawings wherein:

FIG. 1a schematically represents a compact pack of discs during the filtering stage;

FIG. 1b illustrates the phenomenon of uneven distribution of the discs during the reverse-flow stage in the conventional devices;

FIG. 2 is a three-dimensional view, partly in cross-section, of a filtering device according to the first preferred embodiment of the present invention in the filtering stage;

FIG. 3a is an axial cross-sectional view of a filtering device of FIG. 2;

FIG. 3b is a radial cross-section taken along line III-III of FIG. 3a;

FIG. 4 is a cross-sectional view of the filter of FIG. 3 during the reverse-flow stage;

FIG. 5 is a cross-sectional view of a filtering device according to a modified embodiment of the present invention, during the filtering stage;

FIG. 6 shows the filter of FIG. 5 during the reverse-flow stage;

FIG. 7 is a cross-sectional view of further embodiment of the invention, in the filtering stage;

FIG. 8 shows the filter of FIG. 7 in the reverse-flow stage;

FIG. 9 is a still further embodiment in the filtering stage;

FIG. 10 shows the filter of FIG. 9 in the reverse-flow stage;

FIG. 11 is a still further embodiment in the filtering stage; and

FIG. 12 shows the filter of FIG. 11 in the reverse-flow stage;

### DETAILED DESCRIPTION OF THE PREFERRED EMBODIMENT

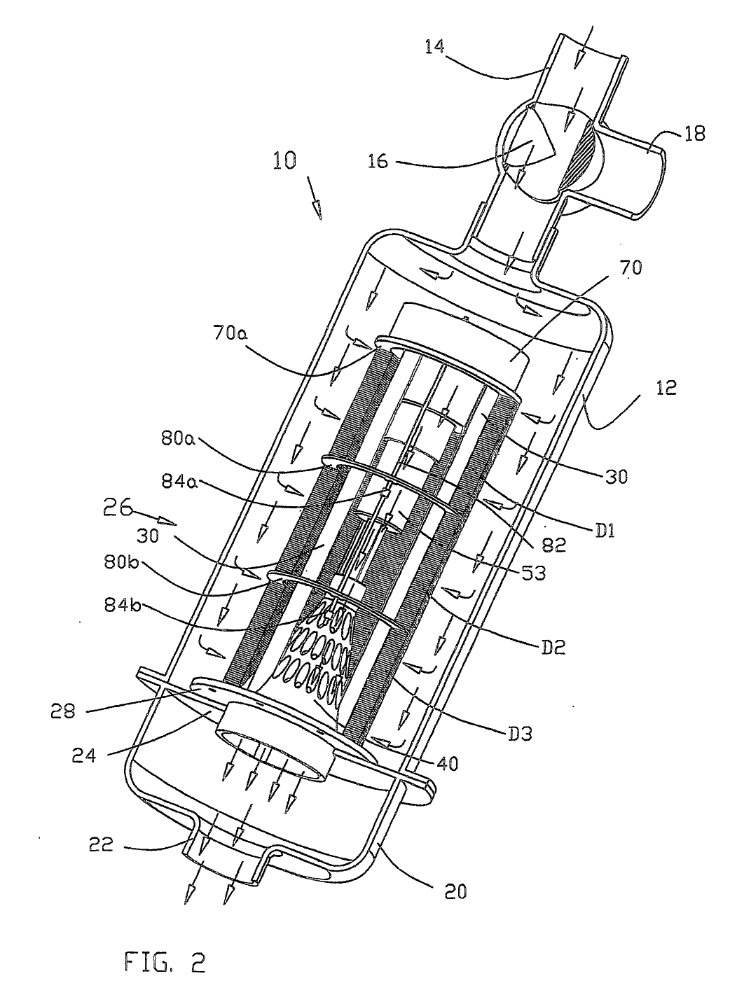

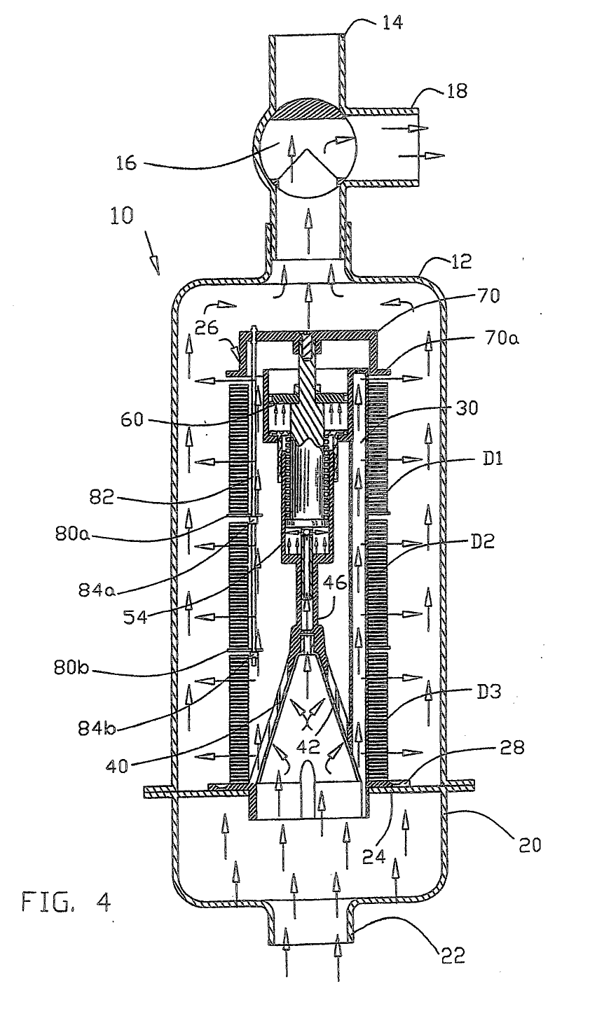

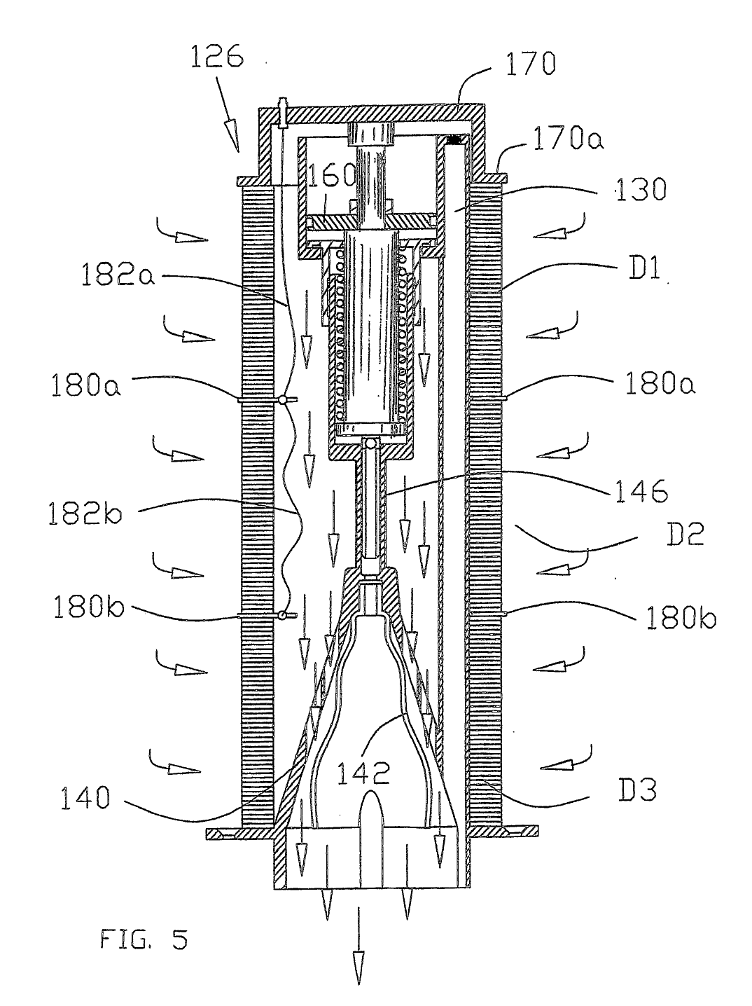

The filtering device generally denoted 10 in FIGS. 2-4 comprises a main housing section 12 with inlet port section 14. A rotary, two-way valve 16 is installed to control the flow of the incoming fluid (mostly water) into the main housing section 12, or to block it and communicate the housing 12 with rinse water outlet 18 (see FIG. 4).

An outlet port housing section 20 is mounted to the housing 12, defining outlet port 22 for the filtered water, as well as inlet port for the backflow, rinsing water (FIG. 4).

The housing sections 12 and 22 are separated by partition wall 24.

Main filter device structure, generally denoted 26, is mounted to the partition wall 24 by flange 28. It comprises a cage formed of three (or more) nozzled tubes 30 around which the battery of filter discs D is supported. Rinsing water is supplied through the tubes 30 during the reverse-flow stage. Hence, the tubes are open at the bottom and closed at the top side thereof.

A unidirectional valve assembly is provided for controlling the flow of water in accordance with the desired two operational stages of the device 10.

In the given example, the valve assembly comprises a cone-shaped perforated cup 40. A flexible lining sleeve 42, (e.g. of rubber), fitting the inside of the cup 40, is placed therein, provided with a hollow, nipple-like extension 44 serving both for affixing the sleeve within the cup 40 and for leading flow of water there through for displacing the discs compacting piston assembly as will be described further below (see path of flow in FIG. 4).

A preferably square (for the sake of rigidness), hollow rod 46 merges from the top of the cup 40 to spring housing member 50. The components 30, 40, 46, 50 and 64 are preferably integrally molded by plastic injection, which is regarded as an additional important advantage of the present invention.

A flanged cap 52 is screw-threaded over the spring housing member 50. Coil spring 54 is compressed between the cap 52 and a shoulder 56a of piston carrier 56.

A piston or plunger 60 is affixed to extension rod 56b, e.g. by retainer ring 62, and surrounded by cylinder 64. The rod 56b is connected to a bell-shaped, discs compacting cap 70, e.g. by screw 72. Rim 70a of the cap 70 fits over the pack of discs, pressing it against the fixed support consisting of the flange 28.

It should be emphasized at this point that the details of construction as above described are not essential to the application of the invention, and other design features, known per se in the art of filter device in general, might as well be adopted, although not recommended in the present context as will be explained further below.

The major point of invention resides in the provision of partition rings 80a, 80b (two in the illustrated example), fitting in-between respective discs, dividing the battery into three groups D₁, D₂, and D₃ of more-or-less equal number of discs.

A series of discs-spacing rods 82 (three in the illustrated example) are provided, depending from the flange 70a and extending parallel to and within (or outside) the battery of discs. The rods 82 extend freely through ears provided for that purpose around the partition rings 80a and 80b, in vertical alignment. Stoppers 84a and 84b are affixed to the spacing rods 82. The stoppers 84a associated with the partition ring 80a are located at a certain, first distance below ring 80a. The stoppers 84b associated with the ring 80b are located at a second, greater distance below the partition ring 80b.

The operation of the filtering device 10 is as follows.

During the normal filtering stage, water (or other fluid) enters the unit 10 through inlet port 14 and forced to penetrate through the battery of discs D. The discs are in a compact state under the force of the spring 54, applied by the cap 70 (the division of the discs into three groups D₁, D₂ and D₃ by the partition rings 80a and 80b has no effect at this stage).

The filtered water flows through the openings in cup 40 while the rubber sleeve 42 shrinks inwardly and does not interfere with such flow.

Once it is determined (by automatic gauging or timer) that a rinsing cycle should start, the direction of the flow is reversed, namely from the outlet 22 in the direction of the inlet 14 which, however, is blocked by closing the valve 16 (see FIG. 4).

The rubber sleeve 42 becomes immediately swelled under the pressure of the incoming water and close the openings of the cone-shaped cup 40. Hence, water is forced to enter the tubes 30 and jet out radially through their nozzles against the filtering discs.

Simultaneously, water is directed through the rod 46, into the space below the piston carrier and further to the space below the piston 60, which starts to rise under the water pressure. This upward movement is transferred to the cap 70 with flaring flange 70a, thus relieving the pressure applied to the discs and facilitating the spacing apart thereof as requested from the effective flushing effect.

The division of the discs into three groups D₁, D₂ and D₃ is attained gradually: First, the partition ring 80a is raised by stopper element 84a, and only later on, ring 80b becomes raised, depending on the initial distance left between the ring 80b and the stopper 84b. (which is necessarily greater than the initial distance between the stopper 84a and the partition ring 80a).

Each group of discs (amounting in the present example to about ⅓ of the total number of discs) is independent regarding the spacing away of discs for rinsing purposes, and therefore the effect of the accumulated self-weight is effectively reduced (approximately by ⅔ with respect to the group D₃ and by ⅓, with respect to group D₂).

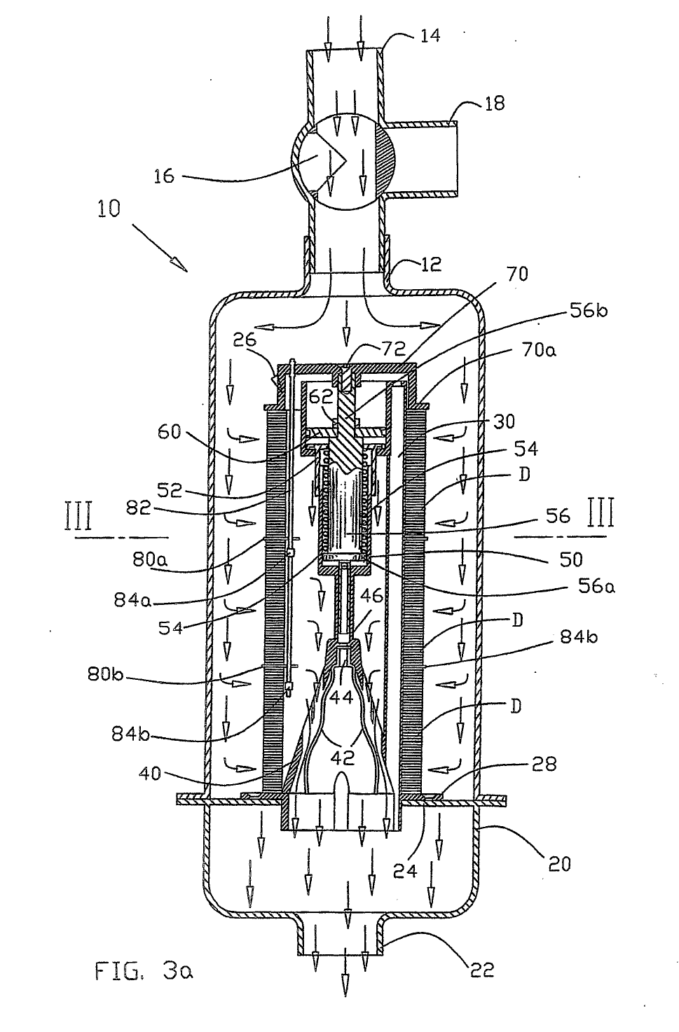

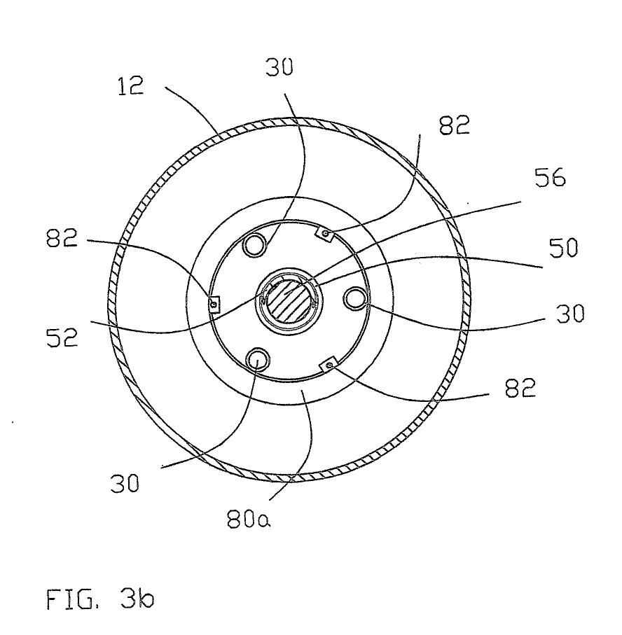

Rinsing water is drained out of the system through outlet 18. At the end of the flushing stage, the operative state of FIG. 3a is resumed by again reversing the water flow direction.

Several variations and modifications of the invention as above exemplified will now be described (through in lesser detail), using as much as applicable designation numerals similar to those applied to the former embodiments.

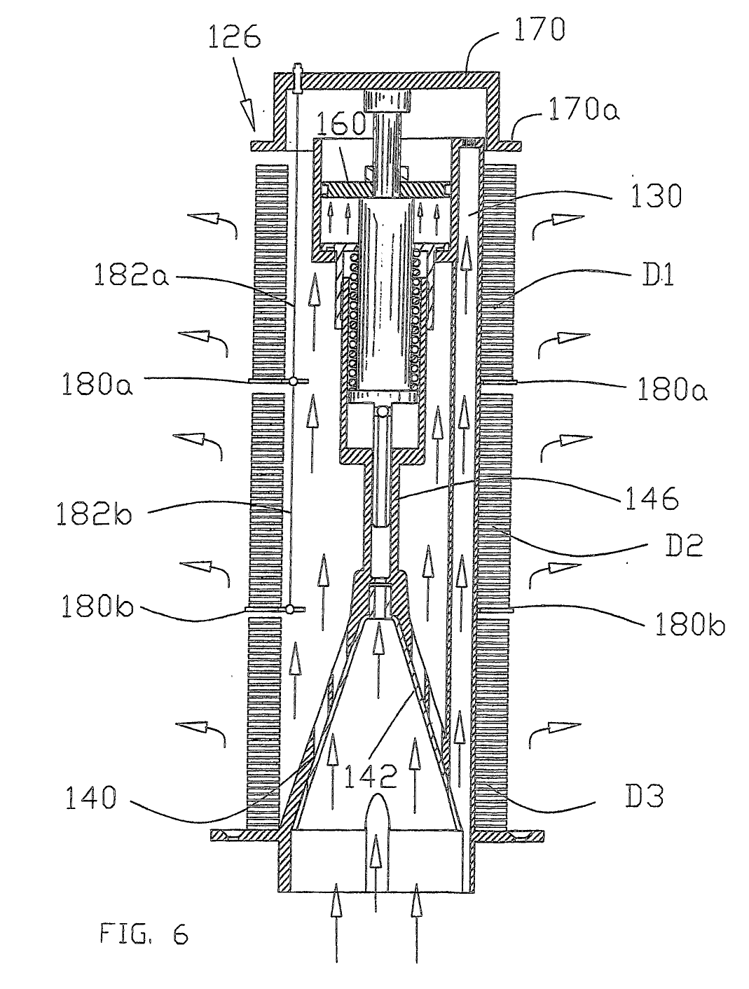

The filtering assembly 126 of FIGS. 5 and 6 is most close to the preceding embodiment, differing only in that the spacing rods 82a and 83b are replaced by wires 182a and 182b tied to the partition rings 180a and 180b, respectively, being of different lengths as required for the step-wise, progressive separation of the discs groups D₁ and D₂.

The remaining details of construction and the mode of operation remain substantially unchanged and therefore need no further explanations.

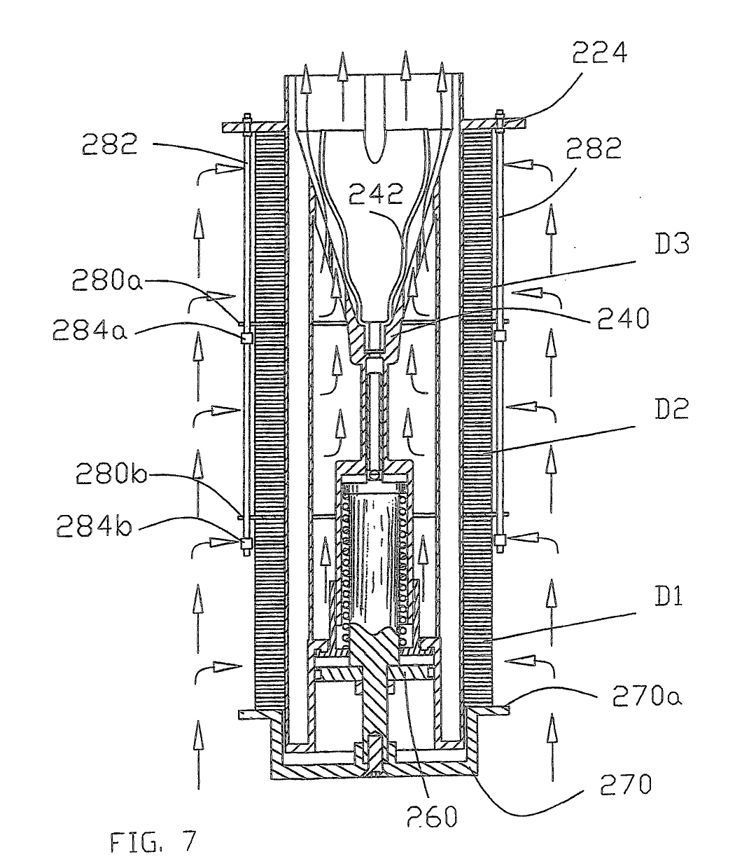

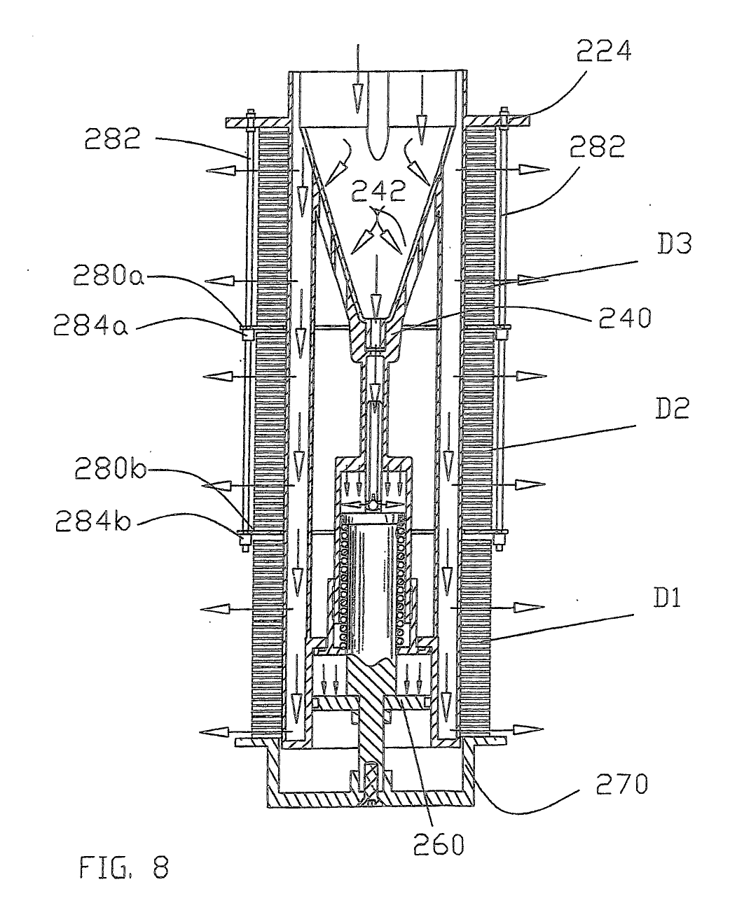

The embodiment of FIGS. 7 and 8 is essentially an ‘upside-down’ version of that of FIGS. 3-4, namely that the piston assembly is installed at the bottom of the unit.

The gravity force of the discs in this case acts reversely, namely that the battery normally rests on the flange 270a of the piston cap 270. Therefore, the spacing rods 282 are affixed to the plate 224 at the outlet side of the filter assembly.

Note that the rods 282 extend outside the discs battery, a design variation that is applicable to any of the previously disclosed embodiments.

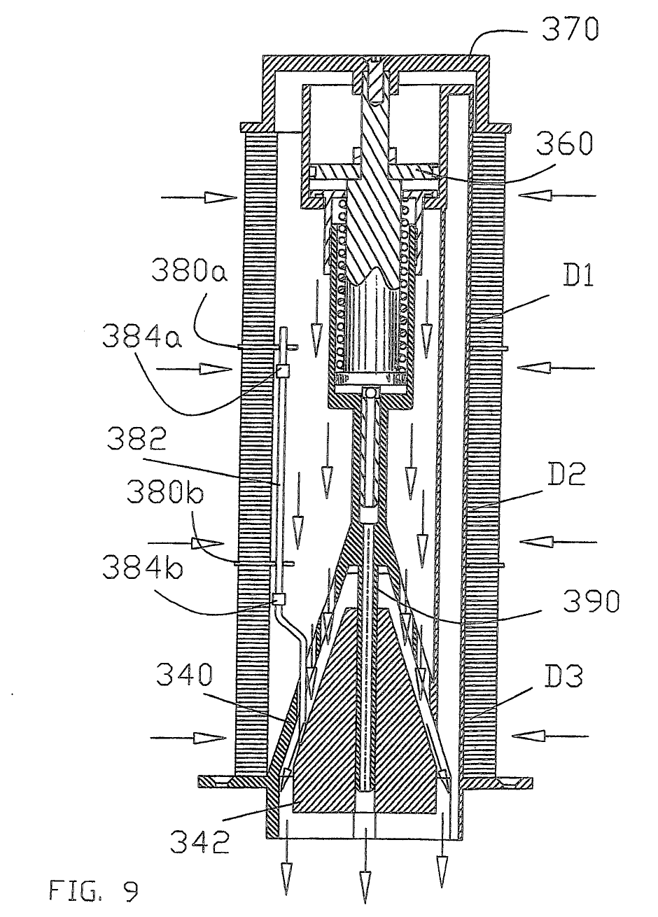

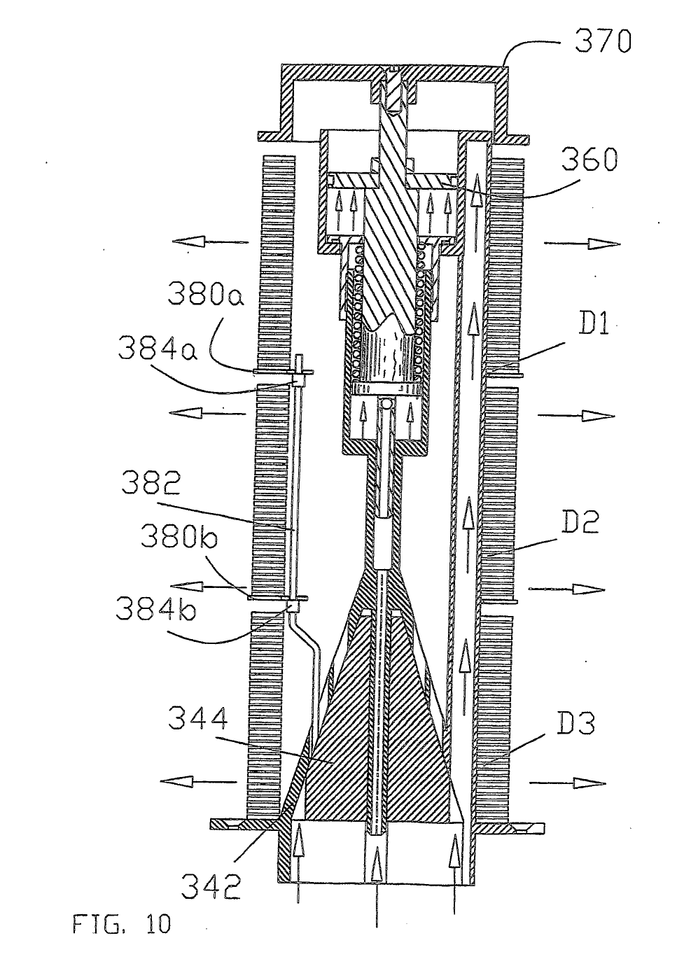

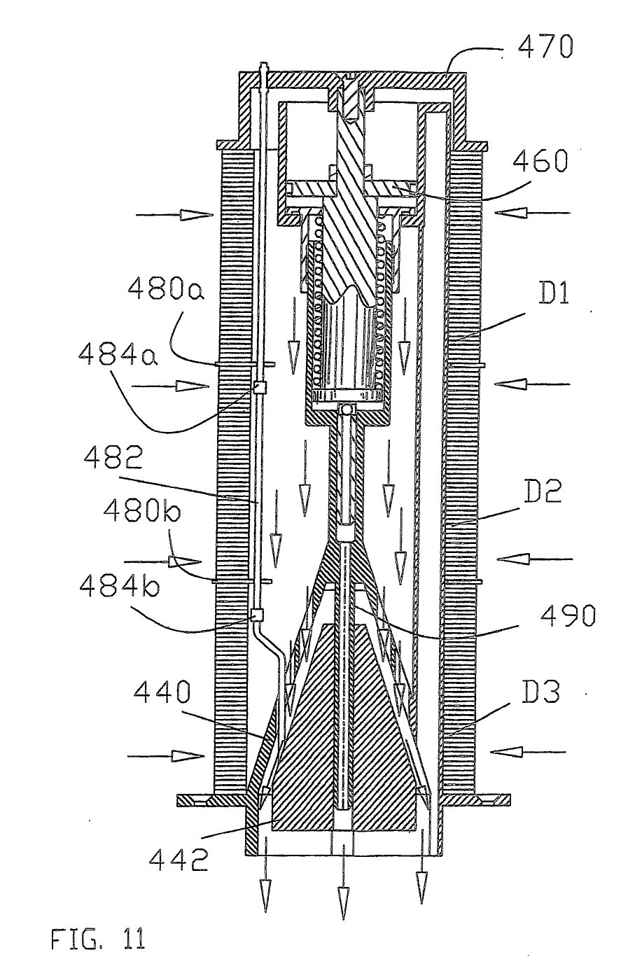

The embodiment of FIGS. 9-10 concern modified spacing rods and the means for their displacement when modes change-over occur.

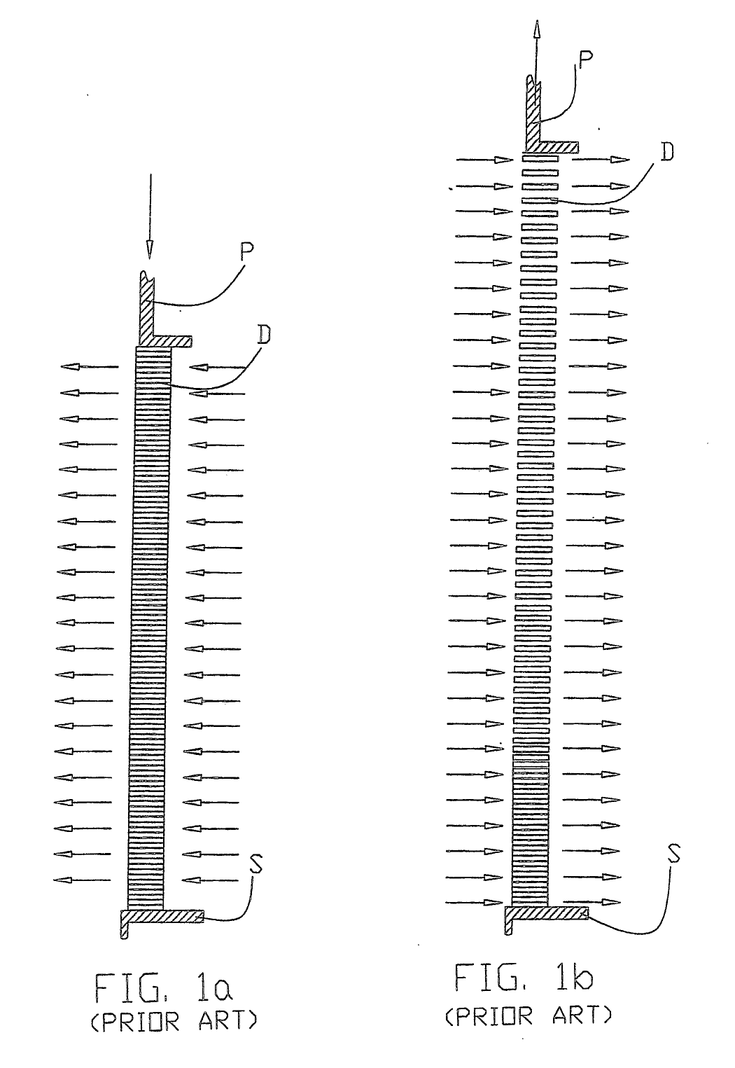

Rather that the flexible sleeve 42 (FIG. 1) functioning as a one-way valve, there is used a solid, cone-shape valve body 342, fitting the inside of the cup 340. The valve body 344 is freely reciprocable over a guide tube 390. Attached to or integrally formed with the valve body 342 are spacing rods 382, provided with stoppers 384a and 384b in the already familiar manner. The transformation from filtering mode (FIG. 9) into rising mode (FIG. 10) takes place as follows. During the filtering stage, the water can flow through the opening of the cup 344 to the outlet as marked by the arrows. The battery of discs is in the compact stage.

Upon reverse of the flow direction (FIG. 10) the impact and pressure of the flushing water causes the closing of the valve body 344 as well as the rising of the piston 360 and cap 370.

The very movement of valve body 344 causes first the positioning of the stopper 384a underneath the partition ring 380a and lifting of the first group of discs D₁, and then, following a further movement of the valve body 344, the lifting of the second group D₂.

Finally the openings of the cup 342 become closed and the full-reverse-flow rising cycle takes place.

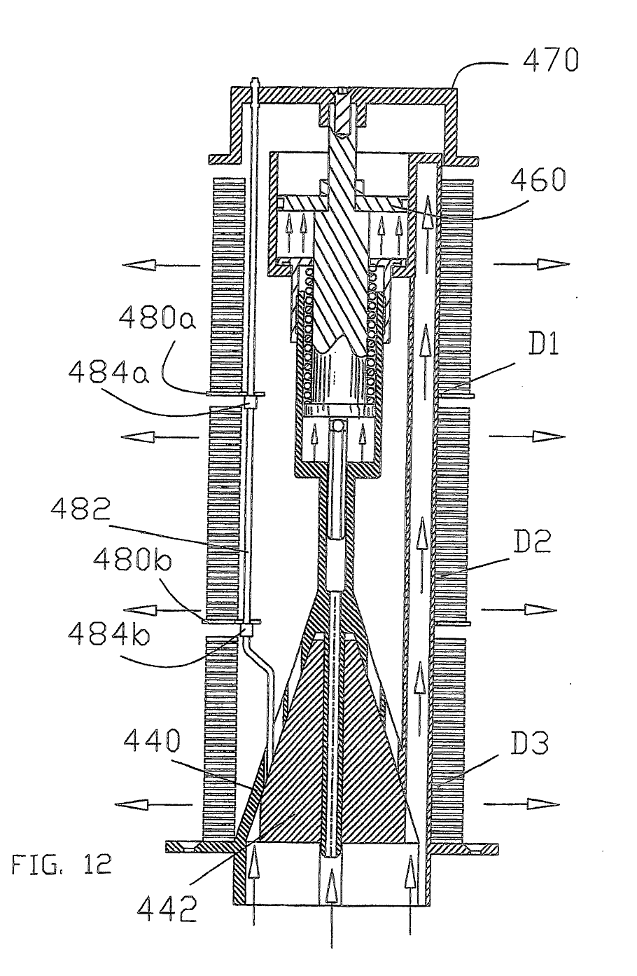

The embodiment of FIGS. 11-12 differs from the preceding one in that the closing of valve body 442 is further enhance be being coupled to the piston cap 470 (and not fully dependent upon the pressure of the incoming water). Hence, the spacing rods 482 are further extend (relative to those of FIG. 10) and positively coupled to cap 470. Upon initiation of the reverse-flow flushing stage. (FIG. 12) the combined forces of water pressure on the valve body 442 and of the piston 460 are applied ensuring safe closing of the valve.

While several embodiments of the present invention have been illustrated by way of example, it is apparent that further embodiments could be developed within the spirit and scope of the present invention. It should be understood that such modifications and adaptations are within the spirit and scope of the present invention, as set forth in the following claims.

What is claimed is:

1. A reverse flow self-rinsing fluid filtering device comprising:
a housing with an inlet port for the fluid to be filtered and an outlet port for the filtered fluid;
a battery of filtering discs positioned in the path of the fluid between the inlet and the outlet ports;
means for applying a compacting force on the battery of discs against a fixed support during the filtering stage of the device; and
means for reliving said force to enable the displacement of the discs away from the fixed support and from each other during the rinsing stage wherein the fluid flows from the outlet port through gaps formed between adjacent discs,
characterized in that partition means are provided interposed between any given number of discs, dividing the battery of discs into a number of groups, whereby in the said rinsing stage each group is supported on one of said partition means.

2. The device as claimed in claim 1 wherein the compacting force applying means comprise a piston operatively coupled to the battery of discs opposite to the fixed support side, spring means being provided for normally urging the piston in the direction of the fixed support.

3. The device as claimed in claim 2 wherein the piston is coupled to the battery of discs via a cap member having a flanged portion which fits over the disc located most remotely from the fixed support.

4. The device as claimed in claim 3 wherein the partition means comprise a series of rings coupled to step-wise spacing means so that movement of the piston away from the fixed support is transferred first to the partition ring which is most remote from the fixed support, than to a less remotely located partition ring, and so forth with respect to the remaining partition rings.

5. The device as claimed in claim 4 wherein the step-wise spacing means comprise a series of rods fastened to the piston cap and extending along the battery of discs, the rods being provided with stopper means adapted to progressively engage the partition rings and move in unison with the movement of the piston.

6. The device as claimed in claim 5 wherein the rods extend along the inner surface of the discs battery.

7. The device as claimed in claim 5 wherein the rods extend along the outer surface of the discs battery.

8. The device as claimed in claim 4 wherein the step-wise spacing means comprise a series of wires fastened to the piston cap and extending along the battery of discs, the wires being provided with stopper means adapted to progressively engage the partition rings and move in unison with the movement of the piston.

9. The device as claimed in claim 8 wherein the wires extend along the inner surface of the discs battery.

10. The device as claimed in claim 8 wherein the wires extend along the outer surface of the discs battery.

11. The device as claimed in claim 3 wherein the partition means comprise a series of rings coupled to step-wise spacing means so that movement of the piston away from the fixed support is transferred first to the partition ring which is most remote from the piston cap member, than to a less remotely located partition ring, and so forth with respect to the remaining partition rings.

12. The device as claimed in claim 11 wherein the step-wise spacing means comprise a series of rods fastened to the fixed support and extending along the battery of discs, the rods being provided with stopper means adapted to progressively engage the partition rings and move in unison with the movement of the piston.

13. The device as claimed in claim 3 further comprising:
a plurality of nozzled tubes supporting the battery of discs;
a one-way valve installed at the outlet port allowing the flow of the filtered fluid therethrough during the filtering stage of operation and directing the rinsing fluid into the nozzled tubes during the reverse flow stage of operation.

14. The device as claimed in claim 13 wherein the valve comprises a cone-shaped perforated cup member and a flexible lining sleeve placed therein open in the direction of said outlet port.

15. The device as claimed in claim 13 wherein the valve comprises a cone-shaped perforated-cup member and a complementary cone-shaped valve body reciprocable within the cup-member between an open, filtered fluid free flowing position and a closed, reverse-flow rinsing position.

16. The device as claimed in claim 15 wherein the partition means comprise a series of rings coupled to step-wise spacing means so that movement of the valve-member away from the outlet port is transferred first to the partition ring which is most remote from the outlet port, than to a less remotely located partition ring, and so forth with respect to the remaining partition rings.

17. The device as claimed in claim 16 wherein the step-wise spacing means comprise a series of rods fastened to the valve-member and extending along the battery of discs, the rods being provided with stopper means adapted to progressively engage the partition rings.

18. The device as claimed in claim 17 wherein the rods extend along the inner surface of the discs battery.

19. The device as claimed in claim 18 wherein the rods are coupled to the piston cap.

20. The reverse flow self-rinsing fluid filtering device substantially as herein claimed in claim 1 and described with reference to FIGS. 2-12 of the accompanying drawings.
